(19) United States
(12) Patent Application Publication
(10) Pub. No.: US 2019/0305916 A1
(43) Pub. Date: Oct. 3, 2019

(54) Efficient Bandwidth Adaptation Operation

(71) Applicant: Mediatek Inc., Hsin-Chu (TW)

(72) Inventor: Pei-Kai Liao, Hsin-Chu (TW)

(21) Appl. No.: 16/366,058

(22) Filed: Mar. 27, 2019

Related U.S. Application Data
(60) Provisional application No. 62/651,323, filed on Apr. 2, 2018.

(51) Int. Cl. H04L 5/00; H04W 48/10; H04W 72/04

(52) U.S. Cl. CPC H04L 5/0094; H04L 5/0039; H04W 72/0453; H04W 48/10; H04W 72/042; H04L 5/005

(57) ABSTRACT

Apparatus and methods are provided for efficient bandwidth adaptation operation. In one novel aspect, the UE configured with a plurality of BWPs receives a paging control for system information (SI) update in an active downlink (DL) BWP by the UE, wherein the paging control for SI update carries an SI-BWP indication that includes BWP information for SI update and obtains system information on a selected BWP, wherein the selected BWP is determined based on the SI-BWP indication. In one embodiment the paging control carries an indication about on which DL bandwidth part the system information broadcast can be received. In another embodiment, the paging control carries an indication about whether system information broadcast can be received in the active DL bandwidth part. In another novel aspect, the paging control indicates an SI update and UE obtains the SI on the initial active BWP.

### CROSS REFERENCE TO RELATED APPLICATIONS

This application claims priority under 35 U.S.C. § 119 U.S. provisional application 62/651,323, entitled “Methods of Efficient Bandwidth Adaptation operation” filed on Apr. 2, 2018, the subject matter of which is incorporated herein by reference.

### TECHNICAL FIELD

The disclosed embodiments relate generally to wireless communication, and, more particularly, to methods and apparatus for efficient bandwidth adaptation operation.

### BACKGROUND

Mobile networks communication continues to grow rapidly. The mobile data usage will continue skyrocketing. New data applications and services will require higher speed and more efficient. Large data bandwidth application continues to attract more consumers. New technologies are developed to meet the growth such as carrier aggregation (CA), which enables operators, vendors, content providers and the other mobile users to meet the increasing requirement for the data bandwidth. However, carrier aggregation assumes multiple RF chains for signal reception even for physically contiguous spectrum, which introduces long transition time to activate more carriers from one carrier for larger data bandwidth and decreases the efficiency of the data transmission.

In frequency bands above 3 GHz, there could be a block of physically continuous spectrum up to hundreds of MHz. The single carrier operation for such large continuous spectrum is more efficient in both the physical (PHY) control, with lower control signaling overhead, and PHY data, with higher trunking gains. It is, therefore, to configure the large contiguous spectrum for large data transmission instead of configuring multiple small spectrum resources. However, from the system level, not all the user equipment (UEs) require large channel bandwidth. Further, for each UE, not all applications require large channel bandwidth. Given that wideband operation requires higher power consumption, the use of the large spectrum resource for control signaling monitoring and low-data-rate services is not ideal for power saving and bandwidth efficiency.

A 5G base station/gNB would support enabling reduced UE bandwidth capability within a wideband carrier and enabling reduced UE power energy consumption by bandwidth adaptation. For UEs configured with multiple bandwidth parts (BWPs), the UE can switch BWP to enable faster data transmission or reduce power consumption or for other purposes. A UE can be configured with one or more BWPs. For a UE, at least one BWP is active at a given time. With BWP configuration, a primary cell (PCell) may be configured with multiple BWPs. The network may not broadcast system information (SI) on each configured downlink (DL) BWPs. The UE may need to switch its active DL BWP from one to another for SI reception. However, when receiving a paging control for SI update, there is no way for a UE to know whether it should stay in the current active DL BWP or should switch its active DL BWP to another BWP for the SI reception.

Improvements and enhancements are required to receive SI with multiple BWPs to facilitate the power-efficient operation for wider bandwidth.

### SUMMARY

Apparatus and methods are provided for efficient bandwidth adaptation operation. In one novel aspect, the UE configured with a plurality of BWPs receives a paging control for system information (SI) update in an active downlink (DL) BWP by the UE, wherein the paging control for SI update carries an SI-BWP indication that includes BWP information for SI update and obtains system information on a selected BWP, wherein the selected BWP is determined based on the SI-BWP indication.

In one embodiment, in an active DL BWP, the UE receives paging control for the SI update, which carries an indication about on which DL bandwidth part the system information broadcast can be received and obtains the SI in the indicated DL bandwidth part. In another embodiment, in an active DL BWP, the UE receives paging control for the SI update, which carries an indication about whether system information broadcast can be received in the active DL bandwidth part. The UE obtains the SI in the active DL bandwidth part if the paging control indicates that there is system information broadcast in the active DL bandwidth part, otherwise, the UE obtains SI in the initial active DL bandwidth part if the paging control indicates that there is no system information broadcast in the active DL bandwidth part.

In one embodiment, the SI-BWP indication includes information of an SI BWP on which a system information broadcast can be received, and wherein the selected BWP is the SI BWP indicated in the SI-BWP indication. The UE switches its active DL BWP to the selected BWP. In another embodiment, the SI-BWP indication includes an indicator indicating whether the active DL BWP carries system information broadcast. The selected BWP is the active DL BWP if the SI-BWP indication indicates that the active DL BWP carries system information broadcast. Otherwise, the selected BWP is the initial active DL BWP if the SI-BWP indication indicates that there is no system information broadcast in the active DL BWP, and wherein the UE switches its active DL BWP to the initial active DL BWP.

In one embodiment, when the UE is activated with a current DL BWP with no common search space, the UE receives information of the active DL BWP containing common search space type and switches to the active DL BWP to receive the paging control for SI update. In one embodiment, the UE stays in the selected BWP after receiving system information until a BWP switching command is received. In another embodiment, the UE stays in the selected BWP after receiving system information until a BWP switching timer expired. In one embodiment, a BWP switching timer value for the BWP switching timer is included in the paging control for SI update.

In another novel aspect, the UE configured with a plurality of BWPs, receiving a paging control in an active downlink (DL) BWP by the UE and receives a paging control for system information (SI) update on the current active DL BWP and obtains system information on the initial active DL BWP.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network with one more BWPs configured in accordance with embodiments of the current invention.

FIG. 2 illustrates an exemplary diagram of a multiple-BWP configuration in connection with system information broadcast in accordance with embodiments of the current invention.

FIG. 3 illustrates exemplary diagrams for the UE with multiple BWPs configured to receive system information upon receiving the paging control indicating a system information update in accordance with embodiments of the current invention.

FIG. 4 illustrates exemplary diagrams for the UE with multiple BWPs configured to receive system information upon receiving the paging control indicating whether the current active BWP contains SI broadcast in accordance with embodiments of the current invention.

FIG. 5 illustrates exemplary diagrams for the UE with multiple BWPs configured to receive system information upon receiving the paging control indicating on which BWP the system information is broadcasted in accordance with embodiments of the current invention.

FIG. 6 illustrates exemplary diagrams for the UE with multiple BWPs configured to receive system information when the current active DL BWP does not have CCS for paging control in accordance with embodiments of the current invention.

FIG. 7 illustrates an exemplary flow chart for the UE with multiple BWPs configured to receive system information upon receiving the paging control indicating an SI update in accordance with embodiments of the current invention.

FIG. 8 illustrates an exemplary flow chart for the UE with multiple BWPs configured to receive system information upon receiving the paging control indicating BWP information for SI update in accordance with embodiments of the current invention.

### DETAILED DESCRIPTION

Reference will now be made in detail to some embodiments of the invention, examples of which are illustrated in the accompanying drawings.

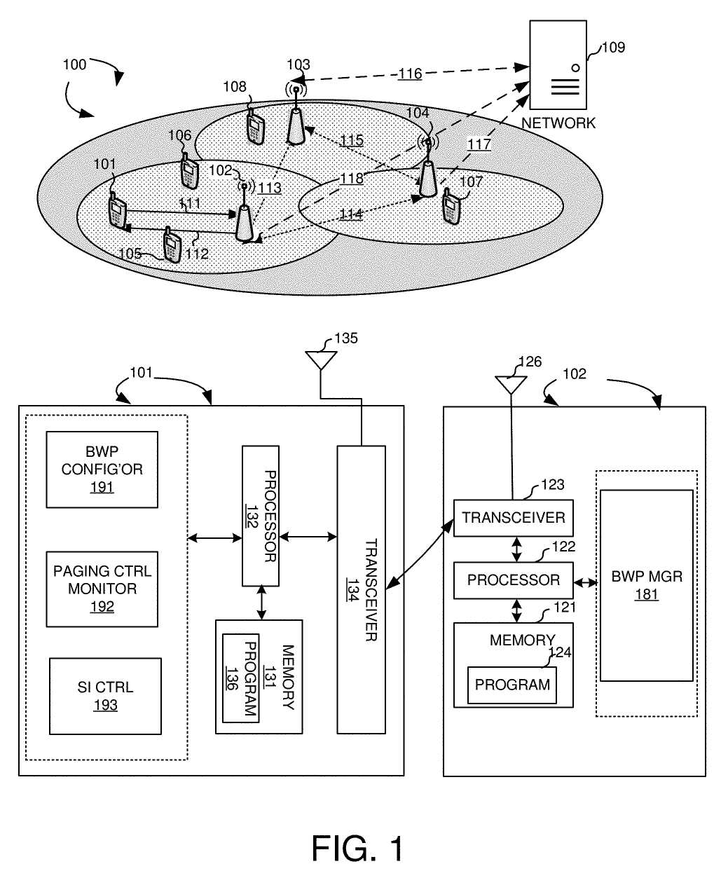

FIG. 1 illustrates a system diagram of a wireless network 100 with one or more BWPs configured in accordance with embodiments of the current invention. Wireless communication system 100 includes one or more wireless networks each of the wireless communication network has fixed base infrastructure units, such as receiving wireless communications devices or base unit 102 103, and 104, forming wireless networks distributed over a geographical region. The base unit may also be referred to as an access point, an access terminal, a base station, a Node-B, an eNode-B, a gNB, or by other terminology used in the art. Each of the base unit 102, 103, and 104 serves a geographic area. Backhaul connections 113, 114 and 115 connect the non-co-located receiving base units, such as 102, 103, and 104. These backhaul connections can be either ideal or non-ideal

A wireless communications device 101 in wireless network 100 is served by base station 102 via uplink 111 and downlink 112. Other UEs 105, 106, 107, and 108 are served by different base stations. UEs 105 and 106 are served by base station 102. UE107 is served by base station 104. UE 108 is served by base station 103.

In one novel aspect, wireless communication network 100 operates with large contiguous radio spectrums. UE 101 while accessing wireless communication network 100, acquires synchronization information and system information using primary SS anchor. An SS block consists of synchronization signals and physical broadcast channel carries necessary system information for starting initial access procedure. UE RF bandwidth adaptation is supported. For more efficient operation of supporting the bandwidth adaptation, one or more bandwidth part (BWP) candidates with configuration parameters are configured per cell (or carrier). The BWP configuration parameters include BWP numerology, such as subcarrier spacing and cyclic prefix (CP) length, the frequency location of the BWP and the BWP bandwidth. A BWP may include SS block. UE 101 may be configured with one or more BWPs per cell (or carrier). UE 101 is configured with at least one active DL/UL BWP at any given time.

FIG. 1 further shows simplified block diagrams of wireless device/UE 101 and base station 102 in accordance with the current invention.

Base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as a BWP manager 181 that sends paging control with one or more indications of BWP for which the SI broadcast can be received and communicates with UEs to implement the wide band operations.

UE 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

UE 101 also includes a set of control modules that carry out functional tasks. These functions can be implemented in software, firmware and hardware. A BWP configurator/circuit 191 configures a plurality BWPs in a wireless network based on a received RRC signal including one or more BWP configurations, wherein a BWP includes a plurality of contiguous physical resource blocks (PRBs), and wherein the UE performs initial access on an initial active downlink (DL) BWP. A paging control monitor/circuit 192 receives a paging control for system information (SI) update in an active DL BWP, wherein the paging control for SI update carries an SI-BWP indication that includes BWP information for SI update. A system information controller/circuit 193 obtains system information on a selected BWP, wherein the selected BWP is determined based on the SI-BWP indication.

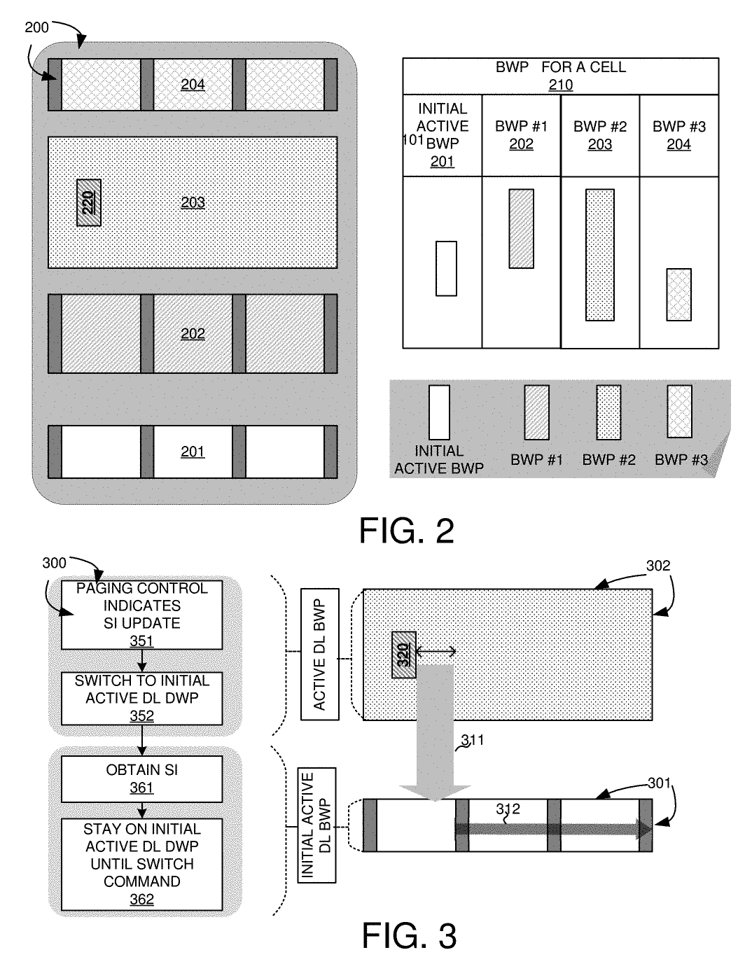

FIG. 2 illustrates an exemplary diagram of a multiple-BWP configuration in connection with system information broadcast in accordance with embodiments of the current invention. In one novel aspect, the UE configured with a plurality of BWPs. The network may not broadcast system information on all the configured BWPs. The UE at any given time has at least one active DL BWP. In one embodiment, the current active DL BWP contains at least one common search space (CSS) type for paging control. In another embodiment, the current active DL BWP does not contain the CSS type for paging control. BWP configuration 200 is an exemplary BWP configuration for the UE. The UE is configured with four BWPs, 201, 202, 203, and 204. Table 210 shows an exemplary BWP partition for BWP configuration 200, which includes BWP 201, BWP #1 202, BWP #2 203, and BWP #3 204. BWP 201 is the initial active DL BWP. The initial active DL or UL BWP is used for initial access of UE, such as the synchronization signal (SS) block reception, remaining minimum system information (RMSI) reception, random access channel (RACH) procedure and etc. In one example, the UE after connection establishment, switches its active DL BWP to DWP #2 203. DWP #2 203 is configured with CCS for paging control. The UE can receive paging control for SI update 220 in BWP #2 203. The UE obtains SI broadcast and/or SI update information based on the paging control for SI update 220. In another embodiment, BWP #3 204 is configured without CCS for paging control. When BWP #3 204 is the current active DL BWP for the UE, the UE cannot receive the paging control for SI update on its active DL BWP. A BWP switching command from the network will instruct the UE to switch to a BWP with the CCS for paging control for SI update. In other embodiments, the UE is configured with one or more BWPs, with one initial active BWP and at least one current active BWP. The current active BWP may or may not contain CCS for paging control for SI update.

When the UE is configured with multiple BWPs, the network may or may not broadcast system information on its current active BWP. The UE receives paging control and determines on which BWP it should receive the system information. In one embodiment, the UE receives paging control on its current active BWP. Based on the received paging control, the UE determines a selected BWP on which it obtains the system information. The UE may stay on the selected BWP until a BWP switch command is received or a BWP switch timer expired. The paging control may indicate which BWP to receive the system information to the UE in different ways. The following diagrams illustrate different ways for the UE to determine which selected BWP to use to obtain system information.

FIG. 3 illustrates exemplary diagrams for the UE with multiple BWPs configured to receive system information upon receiving the paging control indicating a system information update in accordance with embodiments of the current invention. In one embodiment, when the UE's active DL BWP contains CCS type for paging control, the UE obtains the system information on the initial active DL BWP when the paging control for system information update is detected in its active DL BWP. The UE autonomously switches its active DL BWP to the initial active DL BWP for system information reception when it detects a paging control indicating system information update in its current active DL BWP. The UE stays in the initial active DL BWP until it receives an active BWP switch DCI.

An SI procedure 300 is illustrated when the UE receives the paging control indicating a system information update. The UE is configured with an initial active BWP 301 and an active DL BWP 302. The current active DL BWP 302 contain CCS for paging control. Paging control 320 is received on current active DL BWP 302. At step 311, upon receiving the paging control 320 indicating that a system information update, the UE automatically switches to initial active DL BWP 301. At step 312, the UE acquires system information on initial active DL BWP 301.

On the active DL BWP, the UE receives paging control indicating SI update at step 351. The UE, at step 352, switches to initial active DL BWP 302. On initial active DL BWP 301, the UE obtains system information at step 361. In one embodiment, the UE stays on initial active DL BWP 301, at step 362, until a switch BWP command is received. In another embodiment, the UE switches to another BWP upon a BWP switch timer expires. In one embodiment, the timer value for the BWP switch timer is included in the paging control.

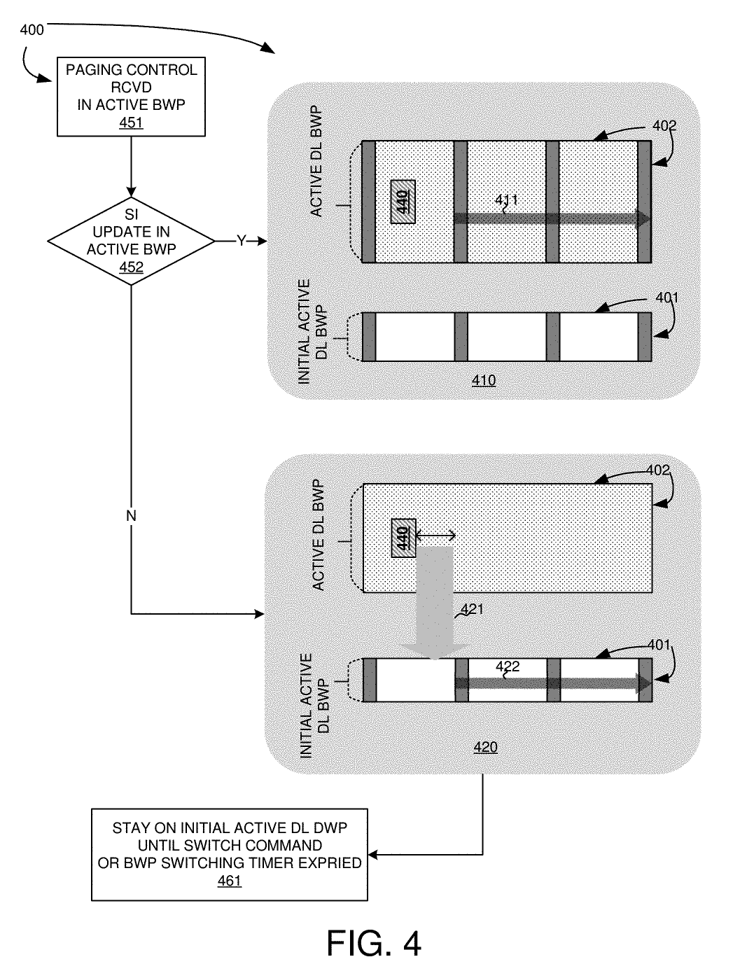

FIG. 4 illustrates exemplary diagrams for the UE with multiple BWPs configured to receive system information upon receiving the paging control indicating whether the current active BWP contains SI broadcast in accordance with embodiments of the current invention. In one embodiment, when the UE's active DL BWP contains CCS type for paging control, the UE obtains the system information in either active DL BWP or the initial active DL BWP when the paging control for system information update is detected/received in its active DL BWP. The UE obtains the system information in its active DL BWP when it detects a paging control for system information update, indicating there is system information broadcast in its active DL BWP. The UE autonomously switches its active DL BWP to the initial active DL BWP for system information reception when it detects a paging control for system information update, indicating there is no system information broadcast in its active DL BWP.

An SI procedure 400 is illustrated when the UE receives the paging control indicating whether the system information is broadcasted on the current active DL BWP. The UE is configured with an initial active BWP 401 and an active DL BWP 402. The current active DL BWP 402 contain CCS for paging control. Paging control 440 is received on current active DL BWP 402. The UE upon receiving paging control 440, determines whether the paging control indicates the system information broadcast is available on the current active DL BWP 402. If the system information broadcast is not available on the current active DL BWP 402, the UE follows procedure 420. The UE switches to initial active DL BWP 401 and at step 421 and acquires system information on initial active DL BWP 401 at step 422.

On the active DL BWP, the UE receives paging control indicating SI update at step 451. The UE, at step 452, determines whether the paging control indicates the SI broadcast/update is available on the current active DL BWP. If yes, the UE performs procedure 410. If not, the UE performs procedure 420. Once the UE performs procedure 420, at step 461, the UE may stay on the initial active BWP until a BWP switch command or a BWP switch timer expires. In one embodiment, the UE stays on initial active DL BWP 401 until a switch BWP command is received. In another embodiment, the UE switches to another BWP upon a BWP switch timer expires. In one embodiment, the timer value for the BWP switch timer is included in the paging control.

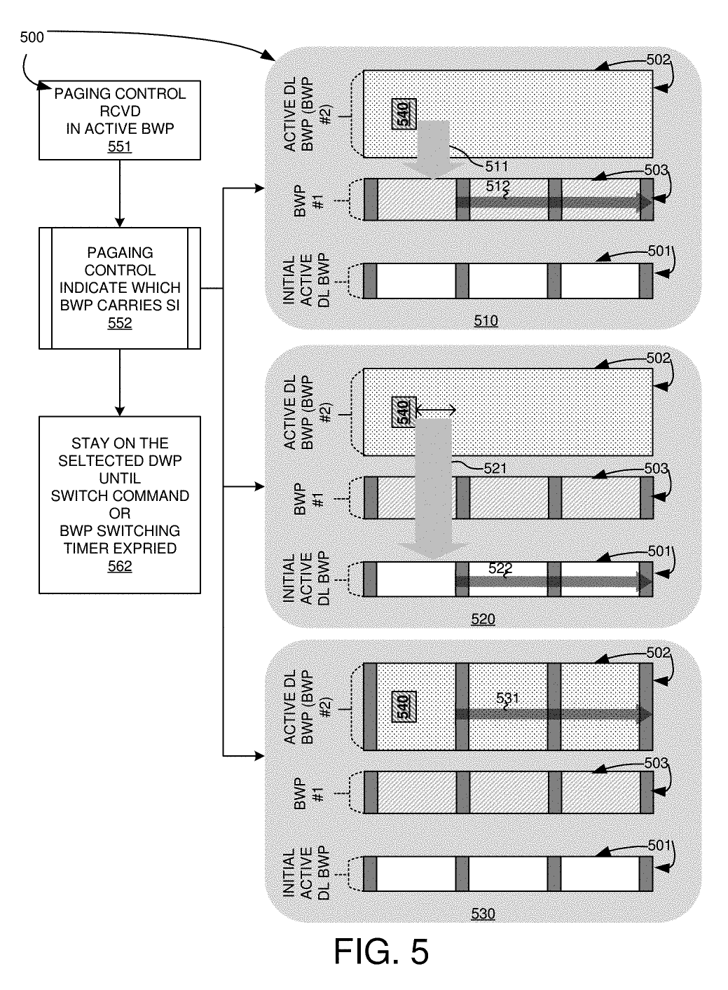

FIG. 5 illustrates exemplary diagrams for the UE with multiple BWPs configured to receive system information upon receiving the paging control indicating on which BWP the system information is broadcasted in accordance with embodiments of the current invention. In one embodiment, when the UE's active DL BWP contains CCS type for paging control, the UE obtains the system information on the configured DL BWP indicated in the paging control for system information update when the paging control is detected in its active DL BWP. In one embodiment, the paging control includes BWP index. In another embodiment, The UE obtains the system information in its active DL BWP when it detects a paging control for system information update, indicating there is system information broadcast in its active DL BWP. The UE autonomously switches its active DL BWP to another DL BWP for system information reception when it detects a paging control for system information update, indicating there is system information broadcast in the indicated DL BWP. In one embodiment, The UE stays in the indicated DL BWP until it receives an active BWP switch DCI. In another embodiment, the UE stays in the indicated DL BWP until a BWP switch timer expires. In one embodiment, the timer value for the BWP switch timer is included in the paging control.

An SI procedure 500 is illustrated when the UE receives the paging control indicating on which BWP the system information is broadcasted. The UE is configured with an initial active BWP 501, an active DL BWP 502, and a BWP#1 503. The current active DL BWP 502 contain CCS for paging control. Paging control 540 is received on current active DL BWP 502. The UE upon receiving paging control 540, determines on which BWP is the system information broadcasted. If the paging control indicates that the system information is broadcasted on BWP #1, the UE performs procedure 510. The UE switches to DL BWP #1 503 at step 511 and acquires system information on BWP #1 503 at step 512. If the paging control indicates that the system information is broadcasted on initial active DL BWP 501, the UE performs procedure 520. The UE switches to initial active DL BWP 501 at step 521 and acquires system information on initial active DL BWP 501 at step 522. If the paging control indicates that the system information is broadcasted on current active DL BWP 502, the UE performs procedure 530. The UE stays on the current active DL BWP 502 and acquires system information on current active DL BWP 502 at step 531.

On the active DL BWP, the UE receives paging control indicating SI update at step 551. The UE, at step 552, determines on which BWP is the system information broadcasted. The UE performs procedure 510 if the paging control indicates that the system information is broadcasted on BWP #1. The UE performs procedure 520 if the paging control indicates that the system information is broadcasted on the initial active DL BWP. The UE performs procedure 520 if the paging control indicates that the system information is broadcasted on the current active DL BWP.

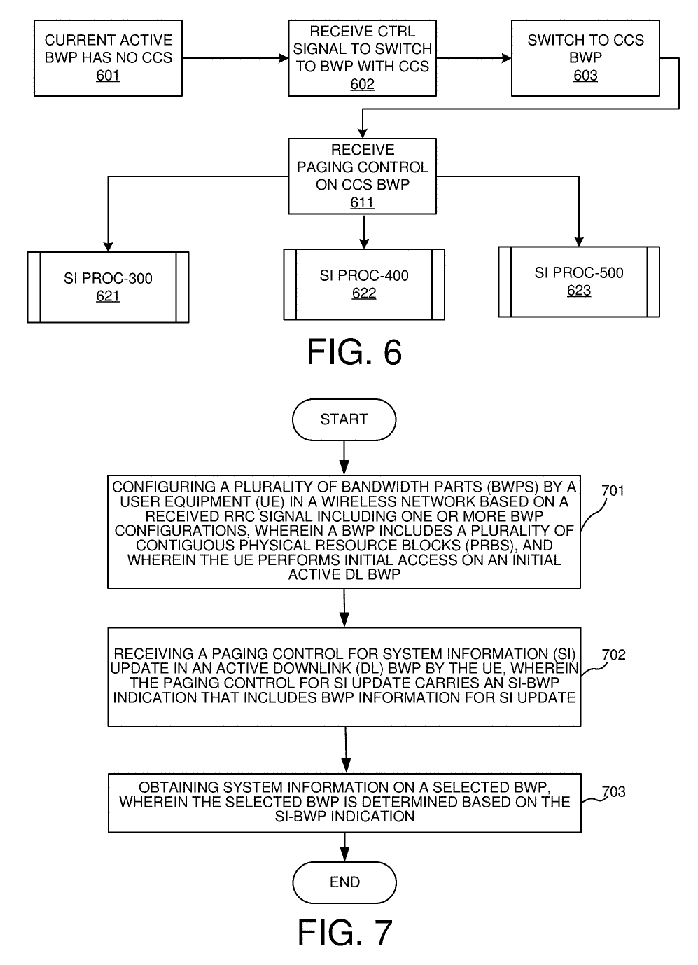

FIG. 6 illustrates exemplary diagrams for the UE with multiple BWPs configured to receive system information when the current active DL BWP does not have CCS for paging control in accordance with embodiments of the current invention. When a UE's active DL BWP does not contain the common search space type for paging control, the UE is switched to a DL BWP containing the common search space type for paging control by UE-specific DCI. Subsequently, the UE follows the same procedure for the case when a UE's active DL BWP contains the common search space type for paging control.

At step 601, the UE is configured with the current active DL BWP without CCS. At step 602, to be able to receive system information, the UE receives a control signal to switch to a BWP with CCS. At step 603, the UE switches to the BWP with CCS as indicated in the control signal or preconfigured. At step 611, the UE receives paging control for system information update on the new BWP with CCS. Upon receiving paging control for SI update on the CCS BWP, the UE is may follow an SI procedure to obtain the system information. The SI procedure can be selected from SI procedure 300, SI procedure 400, and SI procedure 500 as illustrated above. Other procedures in receiving the system information on a CCS BWP can also be used.

FIG. 7 illustrates an exemplary flow chart for the UE with multiple BWPs configured to receive system information upon receiving the paging control indicating an SI update in accordance with embodiments of the current invention. At step 701, the UE configures a plurality of BWPs in a wireless network based on a received RRC signal including one or more BWP configurations, wherein a BWP includes a plurality of contiguous physical resource blocks (PRBs), and wherein the UE performs initial access on an initial active DL BWP. At step 702, the UE receives a paging control for system information (SI) update in an active downlink (DL) BWP by the UE, wherein the paging control for SI update carries an SI-BWP indication that includes BWP information for SI update. At step 703, the UE obtains system information on a selected BWP, wherein the selected BWP is determined based on the SI-BWP indication.

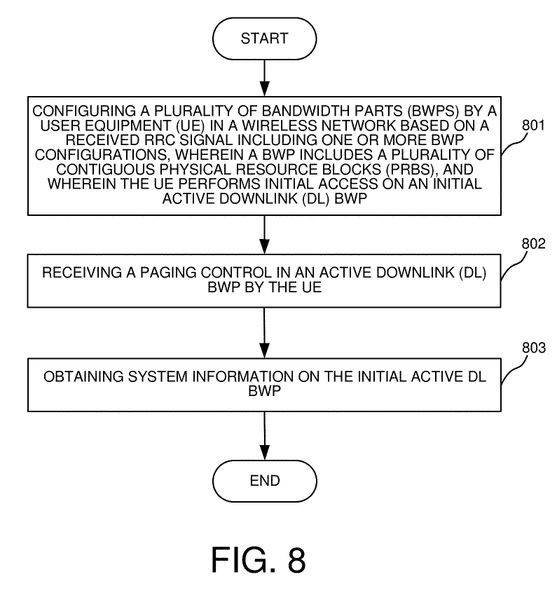

FIG. 8 illustrates an exemplary flow chart for the UE with multiple BWPs configured to receive system information upon receiving the paging control indicating BWP information for SI update in accordance with embodiments of the current invention. At step 801, the configures a plurality of BWPs in a wireless network based on a received RRC signal including one or more BWP configurations, wherein a BWP includes a plurality of contiguous physical resource blocks (PRBs), and wherein the UE performs initial access on an initial active DL BWP. At step 802, the UE receives a paging control in an active downlink (DL) BWP by the UE. At step 803, the UE obtains system information on the initial active DL BWP.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring a plurality of bandwidth parts (BWPs) by a user equipment (UE) in a wireless network based on a received RRC signal including one or more BWP configurations, wherein a BWP includes a plurality of contiguous physical resource blocks (PRBs), and wherein the UE performs initial access on an initial active downlink (DL) BWP;
receiving a paging control for system information (SI) update in an active DL BWP by the UE, wherein the paging control for SI update carries an SI-BWP indication that includes BWP information for SI update; and
obtaining system information on a selected BWP, wherein the selected BWP is determined based on the SI-BWP indication.

2. The method of claim 1, wherein the SI-BWP indication includes information of an SI BWP on which a system information broadcast can be received, and wherein the selected BWP is the SI BWP indicated in the SI-BWP indication.

3. The method of claim 2, wherein the UE switches its active DL BWP to the selected BWP.

4. The method of claim 1, wherein the SI-BWP indication includes an indicator indicating whether the active DL BWP carries system information broadcast.

5. The method of claim 4, wherein the selected BWP is the active DL BWP if the SI-BWP indication indicates that the active DL BWP carries system information broadcast.

6. The method of claim 4, wherein the selected BWP is the initial active DL BWP if the SI-BWP indication indicates that there is no system information broadcast in the active DL BWP, and wherein the UE switches its active DL BWP to the initial active DL BWP.

7. The method of claim 1, wherein the UE is activated with a current DL BWP with no common search space, further comprising: receiving information of the active DL BWP containing common search space type; and switching to the active DL BWP to receive the paging control for SI update.

8. The method of claim 1, wherein the UE stays in the selected BWP after receiving system information until a BWP switching command is received.

9. The method of claim 1, wherein the UE stays in the selected BWP after receiving system information until a BWP switching timer expired.

10. The method of claim 9, wherein a BWP switching timer value for the BWP switching timer is included in the paging control for SI update.

11. A method, comprising:
configuring a plurality of bandwidth parts (BWPs) by a user equipment (UE) in a wireless network based on a received RRC signal including one or more BWP configurations, wherein a BWP includes a plurality of contiguous physical resource blocks (PRBs), and wherein the UE performs initial access on an initial active downlink (DL) BWP;
receiving a paging control in an active downlink (DL) BWP by the UE; and
obtaining system information on the initial active DL BWP.

12. The method of claim 11, further comprising: switching to the initial active DL BWP to receive system information.

13. The method of claim 12, wherein the UE stays in the initial active DL BWP after receiving system information until a BWP switching command is received.

14. A user equipment (UE), comprising:
a transceiver that transmits and receives radio frequency (RF) signals from one or more base stations (BS) in wireless network;
a bandwidth part (BWP) configurator that configures a plurality BWPs based on a received RRC signal including one or more BWP configurations in a wireless network, wherein a BWP includes a plurality of contiguous physical resource blocks (PRBs), and wherein the UE performs initial access on an initial active downlink (DL) BWP;
a paging control monitor that receives a paging control for system information (SI) update in an active DL BWP, wherein the paging control for SI update carries an SI-BWP indication that includes BWP information for SI update; and
a system information controller that obtains system information on a selected BWP, wherein the selected BWP is determined based on the SI-BWP indication.

15. The UE of claim 14, wherein the SI-BWP indication includes information of an SI BWP on which a system information broadcast can be received, and wherein the selected BWP is the SI BWP indicated in the SI-BWP indication.

16. The UE of claim 15, wherein the UE switches its active DL BWP to the selected BWP.

17. The UE of claim 14, wherein the SI-BWP indication includes an indicator indicating whether the active DL BWP carries system information broadcast.

18. The UE of claim 17, wherein the selected BWP is the active DL BWP if the SI-BWP indication indicates that the active DL BWP carries system information broadcast.

19. The UE of claim 17, wherein the selected BWP is the initial active DL BWP if the SI-BWP indication indicates that there is no system information broadcast in the active DL BWP, and wherein the UE switches its active DL BWP to the initial active DL BWP.

20. The UE of claim 14, wherein the UE is activated with a current DL BWP with no common search space, and wherein the UE receives information of the active DL BWP containing common search space type and switches to the active DL BWP to receive the paging control for SI update.

21. The UE of claim 14, wherein the UE stays in the selected BWP after receiving system information until a BWP switching command is received.

22. The UE of claim 14, wherein the UE stays in the selected BWP after receiving system information until a BWP switching timer expired.
